(19) United States
(12) Patent Application Publication
(10) Pub. No.: US 2015/0320091 A1
(43) Pub. Date: Nov. 12, 2015

(54) IRON SUPPLEMENTATION OF RICE KERNELS

(71) Applicant: DSM IP ASSETS B.V., Heerlen (NL)

(72) Inventors: Andrea BULBARELLO, Basel (CH); Georg STEIGER, Basel (CH)

(73) Assignee: DSM IP ASSETS B.V., Heerlen (NL)

(21) Appl. No.: 14/398,057

(22) PCT Filed: May 6, 2013
(86) PCT No.: PCT/EP2013/059331

§ 371 Date: Oct. 30, 2014

(30) Foreign Application Priority Data
May 8, 2012 (EP) 12167060.8
Mar. 7, 2013 (EP) 13158095.3

(51) Int. Cl. A23L 1/10; A23L 1/168

(52) U.S. Cl. CPC A23L 1/1008; A23L 1/168; A23V 2002/00

(57) ABSTRACT

The present invention is directed to reconstituted rice kernels enriched with ferric pyrophosphate, and citric acid and/or a citrate salt. It is also directed to the use of ferric pyrophosphate in combination with citric acid and/or a citrate salt to supplement reconstituted rice kernels with iron. Furthermore, it is directed to a process to prepare reconstituted rice kernels enriched with iron.

The present invention is directed to reconstituted rice kernels enriched with ferric pyrophosphate, and citric acid, a citrate salt or mixtures thereof. It is also directed to the use of ferric pyrophosphate in combination with citric acid, a citrate salt, or mixtures thereof to supplement reconstituted rice kernels with iron. Furthermore, it is directed to a process to prepare reconstituted rice kernels enriched with iron.

Iron deficiency is the most common of all nutritional deficiencies. Approximately 3.7 billion people suffer from this condition, and it is most widespread in children and lactating mothers. Iron deficiency leads to anaemia; overall, 39% of pre-school children and 52% of pregnant women are anaemic, of whom more than 90% live in developing countries.

Anaemia is bad for health and development. In infants and young children, it impairs growth, cognitive development and immunity; at school age it affects school performance and reduces activity levels; at adulthood it reduces work capacity and lowers resistance to fatigue. In pregnant women, it is linked with an increased risk of maternal mortality and illness, as well as an increased risk of pre-term delivery, retarded foetal growth, low birth weight and foetal death soon after birth.

Iron tablets are a possible solution, but require a continuous supply and can cause side effects. In the long term, ensuring adequate iron intake through food is viewed as the best option. For most populations, the best sources of iron are meat products, but these are relatively expensive and little consumed by the poor.

Since rice is the main staple food for more than half of the global population, improving the iron content and bioavailability in rice is a perspective and an effective way to alleviate or even solve this problem. Brown rice and white rice have similar number of calories and carbohydrates. The main differences between the two forms of rice lie in processing and nutritional content. When only the outermost layer of a grain of rice (the husk) is removed, brown rice is produced. To produce white rice, the next layers underneath the husk (the bran layer and the germ) are removed, leaving mostly the starchy endosperm. Several vitamins and dietary minerals are lost in this removal and the subsequent polishing process. A part of these missing nutrients, such as vitamin B₁, vitamin B₃, and iron are sometimes added back into the white rice making it “enriched”, as food suppliers in the US are required to do by the Food and Drug Administration.

However, the iron enriched rice of the prior art is generally not a very efficient source of iron. A cheap and highly bio available iron compound that causes no organoleptic changes is to be used. Unfortunately, the water soluble iron compounds, which are the most bio available, as for example, ferrous sulphate often cause unacceptable colour of flavour changes in the iron enriched rice kernels and is therefore not used. On the other hand ferric pyrophosphate, at neutral pH, is a known nearly water-insoluble iron compound often used in the food industry to fortify infant cereals and chocolate drink powders. Its main advantage is that it causes no adverse colour and limited flavour changes to food vehicles. It is however, as such poorly bioavailable.

Iron fortified rice may be produced by coating an iron source and/or a vitamin premix on rice kernels. Alternatively, rice fortified with micronutrients can be produced in the form of reconstituted rice kernels enriched with vitamins and /or minerals as described in (WO 2005/053433 or in WO2010/020640). These supplemented reconstituted kernels are then mixed in the appropriate ratio with white rice to provide appropriate mineral and vitamin supplementation.

Food products comprising different forms of iron such as: ferric sodium EDTA, reduced iron, ferrous lactate, ferric citrate, ferric pyrophosphate, ferrous sulphate monohydrate, and ferric ammonium citrate brown, have shown good performances related to colour of the food, and good performance related to the taste which is also unchanged compared to the control.

However, such iron enriched food products are often unstable upon long term shelf life (more than 9 month) in conditions of high temperatures (above 30° C.) and high humidity (above 60% relative humidity) which are typical of household conditions in countries where this rice is to be stored and ultimately used. It is believed that this instability (discoloration upon storage) is due to oxidation catalysed by iron.

Moreover, ferric pyrophosphate is very poorly soluble upon cooking of the rice resulting in a rice kernel containing insoluble forms of iron, thus providing very limited supply of bioavailable iron to the population in need of iron supplementation.

Recently, a micronized dispersible ferric pyrophosphate has been developed for food fortification (U.S. Pat. No. 6,616,955). It is based on ferric pyrophosphate nano particles specially formulated with emulsifiers. This product is dispersible in water, providing a somehow improved bioavailability, but the supplementation cost does not allow the food industry to develop food supplemented with bio available iron suitable for developing countries or targeting populations with low income.

The inventor of the present application now surprisingly found a new composition for iron fortification of rice kernels that need cooking in water. These iron supplemented reconstituted rice kernels are cheap (affordable for developing countries), stable (i.e.: do not loose colour during shelf like of the product under high temperature and high humidity conditions), and upon cooking, iron becomes soluble and highly bioavailable within the cooked reconstituted rice kernel, without affecting the colour, the texture or the taste of the final reconstituted rice kernel. When cooked together with normal rice, the reconstituted iron supplemented kernels cannot be discriminated and left aside by the end consumer. Moreover, this reconstituted rice kernel composition only comprises components which are readily authorized for food consumption in most countries of the world.

Therefore, the present invention provides a reconstituted rice kernel comprising
60 to 99 wt.-% comminuted rice matrix material,
0.015 to 10 wt.-% ferric pyrophosphate,
0.01 to 40 wt.-% citric acid, and/or a citrate salt,
further comprising 0 to 5 wt.-% of at least one micronutrient,
wherein citric acid is anhydrous or monohydrate and the salt is selected from potassium citrate, monosodium citrate and trisodium citrate,
wherein the molar ratio of ferric pyrophosphate to citric acid and/or citrate salt is between 0.01 and 20.

Unless specified otherwise in the present specification, all the percentages in the reconstituted rice kernel composition are based on the weight of the rice kernel.

Reconstituted rice kernel according to present invention is to be understood as any rice kernel shaped in the form of a kernel starting from rice particles, semolina or flour.

The reconstituted rice kernel according to the present invention comprises 60 to 99 wt.-% comminuted rice matrix material. The rice matrix material used in the present invention may be broken cracked or otherwise degraded rice grains which are at least partially or predominantly comminuted, such as rice semolina or rice flour.

In a preferred embodiment, the reconstituted rice kernel according to the present invention further comprises 0.5 to 3 wt.-% of an emulsifier preferably selected from lecithins, mono-, or di-glycerides of C₁₄ to C₁₈ fatty acids, or mixtures thereof.

The reconstituted rice kernel according to the present invention comprises 0.015 to 10 wt.-% ferric pyrophosphate. The amount of ferric pyrophosphate in the reconstituted rice kernel according to the present invention is preferably between 0.02 wt.-% and 5 wt.-%, more preferably, between 0.05 and 2 wt.-%. Ferric pyrophosphate also called diphosphoric acid iron (ID) salt (CAS: 10058-44-3), can be purchased from Spectrum Chemical or Dr. Paul Lohmann.

The particle size of the ferric pyrophosphate will influence the required heating time of the reconstituted rice kernel in water to obtain complete dissolution of the ferric pyrophosphate with the citric acid and/or citrate salt within the rice kernel. The larger, the particle size, the longer heating will be required. Therefore, preferred ferric pyrophosphate particle size for use in the composition according to the present invention, have an average particle size between 20 to 60 micrometers. Even more preferred ferric pyrophosphate is micronized ferric pyrophosphate with an average particle size of 2 to 3 micrometers.

The citric acid and/or citrate salt in the reconstituted rice kernel according to the present invention is selected from citric acid anhydrous, citric acid monohydrate, potassium citrate, monosodium citrate and trisodium citrate. The salt is preferably selected from monosodium citrate and trisodium citrate. Monosodium citrate (CAS: 18996-35-5), and trisodium citrate (CAS: 68-04-2) can both be purchased from Spectrum Chemical. Most preferred citrate salt is trisodium citrate in view of its power to solubilise ferric pyrophosphate upon cooking of the rice in presence of water. The amount of citric acid and/or citrate salt is comprised between 0.01 and 40 wt.-%, preferably between 0.05 and 20 wt.-%.

In a preferred embodiment, the reconstituted rice kernel comprises between 0.02 and 5 wt.-% of ferric pyrophosphate, and between 0.05 and 20 wt.-% of citric acid and/or citrate salt.

The molar ratio of ferric pyrophosphate to citric acid and/or citrate in the reconstituted rice kernel according to the present invention is between 0.01 and 20, preferably between 0.1 and 10, more preferably, between 0.5 and 2 in view of the optimal ratio needed to solubilise ferric pyrophosphate upon cooking of the rice in presence of water. The amount of citric acid and citrate salt is adjusted such that the pH is between 5 and 8 preferably between 6 and 7. This is best achieved when the ratio between citric acid and trisodium citrate is between 1:2.5 and 1:1000 preferably between 1:4.4 and 1:100.

The term “micronutrient” as used herein denotes physiologically essential components of the human diet such as vitamins, e.g., vitamin A, vitamin B1, Folic acid, Niacin and vitamin B12, vitamin B2, vitamin E and C, Biotin, Pantothenates, vitamin K and derivatives thereof, as well as minerals and trace elements such as Selenium, Zinc and Calcium. Preferred micronutrients according to the present invention are selected from the micronutrient is selected from vitamin A, vitamin B1 and vitamin B12 or mixtures thereof in view of their lack of coloring effect on the final reconstituted rice kernel.

The micronutrients are present in the enriched reconstituted rice provided by the invention in an amount of from 0 to 5 wt.-%. Preferably, the micronutrients are present in the enriched reconstituted rice provided by the invention in an amount of 0.1 to 5 wt.-%, more preferably in an amount sufficient to provide about 5% to 300% of the RDA (Recommended Daily Allowance for an adult) in 1 g.

The reconstituted rice kernels according to the present invention may further comprise a chelating amino acid such as L-lysine, L-lysine hydrochloride, L-glycine, L-methionine or other amino acids as a replacement for up to 80 wt.-% of the citric acid and/or citrate salt. Indeed, the inventor has shown that chelating amino acids are also efficient in solubilising ferric pyrophosphate upon heating in aqueous media in the presence of citric acid and/or a citrate salt.

Therefore, the present invention also provides a reconstituted rice kernel comprising
60 to 99 wt.-% comminuted rice matrix material,
0.015 to 10 wt.-% ferric pyrophosphate,
0.01 to 40 wt.-% citric acid, and/or a citrate salt,
0.02 to 40 wt.-% chelating amino acid,
further comprising 0 to 5 wt.-% of at least one micronutrient,
wherein citric acid is anhydrous or monohydrate and the salt is selected from potassium citrate, monosodium citrate and trisodium citrate,
wherein the molar ratio of ferric pyrophosphate to citric acid and/or citrate salt is between 0.01 and 20, and
wherein the weight ratio of chelating amino acid to citrate salt is between 1 and 10.

Preferably, reconstituted rice kernels as above, further comprise 0.5 to 3 wt.-% of an emulsifier.

Preferably, the weight ratio of chelating amino acid to citrate salt is between 2 and 8, more preferably, it is between 3 and 6. Preferred amino acid is L-lysine, L-glycine, L, methionine, L-lysine hydrochloride. Even more preferred is L-lysine hydrochloride.

In another embodiment, a colorant is also added to the reconstituted rice kernel in order to give them a color different from the color of the natural rice kernels to be mixed with the reconstituted rice kernels to render the reconstituted rice kernels conspicuous within the natural rice. The preferred colorants are natural colorants selected from dried curcuma powder, and/or carotenoids, preferably beta-carotene and/or lutein, at levels of 0.1-5 ppm to provide an appealing color to the reconstituted rice kernel.

The reconstituted rice kernels according to the present invention are preferably in a dry form. Dry means in the present context a water content below 15%. “kernel” is not limited to a shape in a typical natural rice kernel, but is intended to comprise any shape of the kernel. Preferably the present invention relates to a reconstituted rice kernel in the form, shape texture and taste which cannot be discriminated from natural rice kernels.

The reconstituted rice kernels according to the present invention are extremely stable when stored in high temperature and high humidity. Moreover, upon mixing with water and cooking, ferric pyrophosphate completely dissolves with the help of the citric acid and/or citrate salt, and optionally with the help of the chelating amino acids. The cooking needs to be performed by heating the rice kernels in water at a temperature comprised between 80 to 120° C. for 10 to 120 minutes. Preferably the cooking is performed by boiling around 100° C. under atmospheric pressure until ferric pyrophosphate is completely solubilised with the citric acid and/or citrate salt. Usually this is done within 30 minutes. The cooking step can optionally be performed under pressure. In such a case, the person skilled in the art will of course reduce the heating time accordingly depending on the pressure and temperature applied.

In another embodiment, the present invention provides the use of ferric pyrophosphate and citric acid and/or a citrate salt selected from potassium citrate, monosodium citrate and trisodium citrate in a method for producing a reconstituted rice kernel, wherein the molar ratio of ferric pyrophosphate to citric acid and/or citrate salt is between 0.01 and 20, preferably, between 0.1 and 10, more preferably between 0.5 and 2 in view of the optimal ratio needed to solubilise ferric pyrophosphate upon cooking the rice in presence of water. The amount of citric acid and citrate salt is adjusted such that the pH is between 5 and 8 preferably between 6 and 7.

In yet another embodiment, the present invention provides an iron enriched rice comprising white natural rice kernels and reconstituted rice kernels according to the present invention, wherein the rice contains 0.1 to 10% of reconstituted rice kernels.

Reconstituted rice according to the present invention are prepared according to any method know to the person skilled in the art. In a preferred embodiment, reconstituted rice according to the present invention is prepared by a process comprising the following steps:
(a) dry heat treatment of the rice matrix (pre-treatment step);
(b) comminuting of the rice matrix;
(c) adding water and/or steam to the comminuted rice matrix material to obtain a paste containing about 15 to 40 wt.-% of water (hydration step);
(d) adding 0.015 to 10 wt.-% ferric pyrophosphate, 0.01 to 40 wt.-% citric acid and/or citrate salt, selected from potassium citrate, monosodium citrate and trisodium citrate, and optionally, at least one micronutrient to the paste;
(e) exposing the paste obtained in the preceding steps to shear force while heating it to about 70 to 110° C. for no more than about 10 minutes until the rice starch is semigelatinized; (preconditioning step);
(f) forming the semigelatinized mass to strands and cutting them to obtain grains similar or equal to the size of rice grains; and (forming step);
(g) drying the grains to a moisture content of no more than 15 wt.-% (drying step).

Preferably, step d) is performed after step e).

In a preferred embodiment, 0.5 to 3 wt.-% of at least one emulsifier is added to the water and/or steam of step (c).

The invention is further illustrated by the following examples:

### EXAMPLES

### Example 1

### Iron Release During Cooking Procedure

### Introduction

The amount of iron ions released from two different reconstituted rice samples, (with and without Tri-Sodium-Citrate) fortified with Iron-Pyrophosphate was followed, during a simulated cooking procedure, by employing the methodology as described below.

### Materials and Methods

The samples used in the study are listed on table 1.

TABLE 1
Samples employed list and description

| | Iron Fortification level | Tri-Sodium-citrate |
|---|---|---|
| Samples | (mg Fe/g of rice) | (mg/g of rice) |
| Nutririce 1 | 3 | — |
| Nutririce 2 | 3 | 40 |
| Blank (Uncle ben's) | — | — |

### Rice Cooking Procedure

50 g of NutriRice are weighted with the help of a balance and then placed in a beaker, subsequently 150 g of tap water are added and the mixture is stirred for about 30 seconds. After this procedure the NutriRice is sieved and 250 g of tap water are added. The sample is then placed into an oven at 120° C. for 30 minutes.

After 30 minutes the sample is taken out from the oven and the excess of water is quickly poured off (the kernels tent to adsorb the water very fast) by the use of a tea-sieve.

### Iron Determination of the Rice Cooking Water

The decanted rice cooking water is cooled by using an ice-bath, and then centrifuged for 15 minutes at 22° C. and at 3000 rpm/minute.

After the above described procedure, 3.0 mL of the obtained supernatant clear rice water (might be diluted because of high concentration issues) is pipetted in a 10 mL plastic tube (Corning 430791 or Falcon 352097), subsequently 5 mL sodium-acetate buffer 0.075M with a pH of 6.8, 1 mL of a (0.15 M) Hydroxilamine Hydrochlorate and 1 mL of 1,10 -phenanthroline solution (5.6 mM) are added. The tubes are vortexed and rested for about 1 hour in a dark environment.

The absorbance of the samples is measured with a spectrophotometer (Perkin Elmer Lambda Abs. max˜510 nm).

In all analysis the samples are measured versus a blank which is obtained by employing unfortified rice water and the previously listed reagent solutions.

### Results and Discussion

First of all a calibration curve was built by using centrifuged rice (commercial unfortified Uncle Ben's rice) cooking water with additions of known amount of iron III+ (from a Sigma Aldrich standard solution for atomic absorption analysis), the reducing agent (Hydroxilamine Hydrochloride), the dye (1,10-Phenanthroline) and the pH 6.8 acetate buffer. Three different calibration curves were performed; therefore the experimental points allow drawing a calibration curve correlating absorbance at 510 nm with ppm concentration Fe III+

The two Nutririce products were then cooked as described in the materials and methods section, as “blank” a commercial unfortified rice (Uncle Ben's) was used. Two sets of analysis were performed (in replicates), the first was dealing with the rinsing water used in order to wash the rice before the cooking procedure (table 2) and the second set of analysis was performed in order to assess the amount of iron ions released in the remaining (after the cooking procedure) cooking water (table 3).

TABLE 2
Iron ions released (rinsing water)

| | decanted | mg of total iron ions added in | % of total iron |
|---|---|---|---|
| | water | the entire rice sample | ions released |
| samples | (g) | (50 g rice sample) | from the rice |
| blank | 141 | 0 | 0.042 |
| blank | 140 | 0 | 0.04 |
| Nutririce 1 | 130 | 150 | 0.038 |
| Nutririce 1 | 132 | 150 | 0.04 |
| Nutririce 2 | 133 | 150 | 0.442 |
| Nutririce 2 | 75 | 150 | 0.29 |

TABLE 3
Iron ions released (cooking water)

| | decanted | mg of total iron ions added | % of total iron ions |
|---|---|---|---|
| | water | in the entire rice sample | released from the |
| samples | (g) | (50 g rice sample) | rice |
| blank | 163 | 0 | 0.048 |
| blank | 178 | 0 | 0.05 |
| Nutririce 1 | 79 | 150 | 0.28 |
| Nutririce 1 | 75 | 150 | 0.29 |
| Nutririce 2 | 146 | 150 | 21.85 |
| Nutririce 2 | 68 | 150 | 11.94 |

As table 2 clearly shows, already when the rice is washed before cooking, the sample Nutririce 2 (containing Fe-Pyrophosphate and Tri-Sodium-Citrate) releases some iron ions, while the same phenomena is practically not observed when the analyzed rinsing water comes from the sample named as Nutririce 1.

The same trend is then observed when the cooking water is analyzed, as table 3 points out. As observable for the samples Nutririce 2, some variability in the amount of decanted water and in the amount of iron released was detected. Nevertheless the amount of iron released in the rice cooking water, when Tri-Sodium-Citrate is present, is significantly (on average fifty times more) higher then when the citrate salt is absent.

### CONCLUSION

The sets of experiments and analysis performed have clearly shown that when iron fortified Nutririce contains Tri-Sodium-Citrate, the iron ions are released (and therefore are more bioavailable) during the cooking procedure.

### Example 2

### Influence of Citrate on Iron Release

The amount of iron ions released from three different Nutririce samples, fortified with Iron-Pyrophosphate was followed, during a simulated cooking procedure, by employing an in-house developed methodology.

### Materials and Methods

The samples used in the study are listed on table 4.

TABLE 4
Samples employed list and description

| | | | | Citric |
|---|---|---|---|---|
| | | Iron Fortification | Tri-Sodium- | Acid |
| | Sample | level | citrate | (mg/g |
| Samples | Code | (mg Fe/g rice) | (mg/g rice) | rice) |
| Uncle Ben's Blank | 1 | — | — | — |
| Nutririce Bühler | 2 | 3 | — | — |
| Nutririce Summer | 3 | 4 | 28.5 | 10.4 |
| Nutririce Winter | 4 | 4 | 37.6 | 1.32 |

The Nutririces named “Summer” and “Winter” were produced by using two different premixes (obtained from Vigui) containing different amount of tri-sodium-citrate and citric acid.

### Rice Cooking Procedure

Different cooking procedures were followed as here below described:

### Whole Rice Cooking Procedure 1

50 g of rice are weighted with the help of a balance and then placed in a 600 mL beaker, subsequently 150 g of tap water are added and the mixture is stirred for about 30 seconds. After this procedure the NutriRice is sieved and 250 g of tap water are added. The sample is then placed into an oven at 120° C. for 30 minutes.

After 30 minutes the sample is taken out from the oven and the excess of water is quickly poured off (the kernels tent to adsorb the water very fast) by the use of a tea-sieve.

### Whole Rice Cooking Procedure 2

5 grams of rice are weighted with the help of a balance and then placed in a 50 mL plastic tube, subsequently 25 mL of boiling water are added and the tube is shaken by hand. The sample is then placed into an oven at 120° C. for 30 minutes.

After 30 minutes the plastic tube is shaken again and placed in an ice bath in order to cool down and the content finally sieved in order to separate the solids from the cooking water.

### Milled Rice Cooking Procedure

100 grams of rice are milled at 6000 repetition per minute by using a Retsch 200 mill, the milled rice is then sieved through a 2 mm sieve.

1 gram of milled rice is weighted with the help of a balance and then placed in a 50 mL plastic tube, subsequently 40 mL of boiling water are added and the tube is shaken by hand. The sample is then placed into an oven at 120° C. for 30 minutes.

After 30 minutes the plastic tube is shaken again and placed in an ice bath in order to cool down and the content finally sieved in order to separate the solids from the cooking water.

### Iron Determination of the Rice Cooking Water

The decanted rice cooking water is cooled by using an ice-bath, and then it is centrifuged for 15 minutes at 22° C. and at 3000 rpm/minute.

After the above described procedure, 3.0 mL of the obtained supernatant clear rice water (might be diluted because of high concentration issues) is pipetted in a 10 mL plastic tube (Corning 430791 or Falcon 352097), subsequently 5 mL sodium-acetate buffer 0.075 M with a pH of 6.8, 1 mL of a (0.15 M) Hydroxilamine Hydrochlorate and 1 mL of 1,10 -phenanthroline solution (5.6 mM) are added. The tubes are vortexed and rested for about 1 hour in a dark environment.

The absorbance of the samples is measured with a spectrophotometer (Perkin Elmer Lambda Abs. max˜510 nm).

In all analysis the samples are measured versus a blank which is obtained by employing unfortified rice water and the previously listed reagent solutions.

### Results and Discussion

First of all a calibration curve was built by using centrifuged rice (commercial unfortified Uncle Ben's rice) cooking water with additions of known amount of iron 3+ (from a Sigma Aldrich standard solution for atomic absorption analysis), the reducing agent (Hydroxilamine Hydrochloride), the dye (1,10-Phenanthroline) and the pH 6.8 acetate buffer. Three different calibration curves were performed, therefore the experimental points obtained are the result of three calibration curves plotted and interpolated together.

### Whole Rice Cooking Iron Release

The different samples behave differently (consistency and aspect) after 30 minutes cooking.

Therefore, in order to better analyze the cooked rice water an additional filtration step was employed (Millex GP 0.22 μm).

After cooking and after centrifugation/filtration steps, two sets of analysis were performed (true triplicates, three times the cooking procedure and three times iron assay), the first was dealing with the rinsing water used in order to wash the rice before the cooking procedure (table 5) and the second set of analysis was performed in order to assess the amount of iron ions released in the remaining (after the cooking procedure) cooking water (table 6).

TABLE 5
Iron ions released (rinsing water whole rice)

| | | mg of total iron ions | |
|---|---|---|---|
| | decanted | added in the | % of total iron |
| | water | entire rice sample | ions released |
| samples | (g) | (50 g rice sample) | from the rice |
| Uncle Ben's Blank | 137 ± 1 | 0 | <L.O.D. |
| Nutririce Bühler | 131 ± 3 | 150 | 0.039 ± 0.001 |
| Nutririce Summer | 132.3 ± 0.6 | 200 | 0.52 ± 0.02 |
| Nutririce Winter | 133.3 ± 0.6 | 200 | 0.26 ± 0.009 |

TABLE 6
Iron ions released (cooking water whole rice)

| | | mg of total iron | % of |
|---|---|---|---|
| | decanted | ions added in the | total iron ions |
| | water | entire rice sample | released from the |
| samples | (g) | (50 g rice sample) | rice |
| Uncle Ben's Blank | 158 ± 11.4 | 0 | <L.O.D. |
| Nutririce Bühler | 82.3 ± 10 | 150 | 0.024 ± 0.003 |
| Nutririce Summer | 186 ± 10.3 | 200 | 4.77 ± 0.3 |
| Nutririce Winter | 175 ± 1.3 | 200 | 2.61 ± 0.11 |

As table 5 clearly shows, already when the rice is washed before cooking, the sample named as “Nutririce Summer” (theoretically with a pH around 5 when hydrated) releases the highest amount of iron ions, followed by the sample called “Nutririce Winter” (theoretically with a pH around 6 when hydrated) while the same phenomena is practically not observed when the analyzed rinsing water comes from the sample named as “Nutririce Bühler” which does not contains any source of citrate ions.

The same trend was also observed when the rice cooking waters were analyzed, as table 6 points out. Moreover it is possible to observe that the sample named as “Nutririce Bühler” absorbs much more water during the cooking procedure.

The two Nutririce samples called “Summer ” and “Winter” were also analyzed after a different cooking procedure, described in the materials and methods section as “Whole rice cooking procedure 2”. Also in this case (table 7) the “Nutririce Summer” was releasing a higher amount of iron ions compared to the sample “Nutririce Winter”.

TABLE 7
Iron ions released (cooking water from whole rice cooking procedure 2)

| | | mg of total iron ions | |
|---|---|---|---|
| | | added in the entire | % of total iron |
| | decanted water | rice sample | ions released |
| samples | (g) | (5 g rice sample) | from the rice |
| Nutririce Summer | 7.8 ± 0.1 | 20 | 2.47 ± 0.09 |
| Nutririce Winter | 7 ± 0.6 | 20 | 1.6 ± 0.16 |

### Milled Rice Cooking Iron Release

The same experiments and measurements were performed by employing cooking water from milled rice. As table 8 clearly shows, exactly the same trend observed for the whole rice cooking water analysis was outlined.

TABLE 8
Iron ions released (cooking water milled rice)

| | | mg of total iron | % of |
|---|---|---|---|
| | decanted | ions added in the | total iron ions |
| | water | entire rice sample | released from |
| samples | (g) | (50 g rice sample) | the rice |
| Uncle Ben's Blank | 33.5 | 0 | <L.O.D. |
| Nutririce Bühler | 35 | 150 | 0.52 |
| Nutririce Summer | 34.375 ± 0.17 | 200 | 9.02 ± 0.19 |
| Nutririce Winter | 34.15 ± 0.33 | 200 | 4 ± 0.12 |

### CONCLUSION

The sets of experiments and analysis performed have clearly shown that when iron fortified Nutririce contains citrates ions sources (tri-sodium-citrate and citric acid) the iron ions are better released. Concerning iron ions release, the pH value of the solution containing citrates (and therefore the combination of citric acid and tri-sodium-citrate which are forming a citrate buffer) plays a very important role, the lower the pH is and the higher iron ions release rate is observed. Instead when no citrates are added into the Nutririce blend the iron release is very limited.

1. Reconstituted rice kernel comprising,
60 to 99 wt.-% comminuted rice matrix material,
0.015 to 10 wt.-% ferric pyrophosphate,
0.01 to 40 wt.-% citric acid, and/or a citrate salt,
further comprising 0 to 5 wt.-% of at least one micronutrient,
wherein citric acid is anhydrous or monohydrate and the salt is selected from potassium citrate, monosodium citrate and trisodium citrate,
wherein the molar ratio of ferric pyrophosphate to citric acid and/or citrate salt is between 0.01 and 20.

2. A reconstituted rice kernel according to claim 1, wherein it further comprises 0.5 to 3 wt.-% of an emulsifier.

3. A reconstituted rice kernel according to claim 2, wherein the emulsifier is selected from lecithins, mono-, or di-glycerides of C₁₄ to C₁₈ fatty acids, or mixtures thereof.

4. A reconstituted rice kernel according to claim 1, wherein the amount of ferric pyrophosphate is between 0.02 and 5 wt.-%, and wherein the amount of citric acid and/or citrate salt is between 0.05 and 20 wt.-%.

5. A reconstituted rice kernel according to claim 1, wherein the molar ratio of ferric pyrophosphate to citric acid and/or citrate salt is comprised between 0.1 and 10.

6. A reconstituted rice kernel according to claim 1, wherein, the citrate salt is trisodium citrate.

7. A reconstituted rice kernel according to claim 1, wherein the micronutrient is selected from vitamin A, vitamin B1 and vitamin B12 or mixtures thereof.

8. A reconstituted rice kernel according to claim 1, wherein the amount of at least one micronutrient is between 0.1 and 5 wt.-%.

9. A reconstituted rice kernel according to claim 1, wherein the rice kernel further comprises 0.02 to 40 wt.-% of a chelating amino acid and wherein the weight ratio of chelating amino acid to citric acid and/or citrate salt is between 1 and 10.

10. A reconstituted rice kernel according to claim 9, wherein the weight ratio of chelating amino acid to citric acid and/or citrate salt is between 3 and 6.

11. A reconstituted rice kernel according to claim 9, wherein the amino acid is L-lysine hydrochloride.

12. Use of ferric pyrophosphate and citric acid and/or a citrate salt selected from potassium citrate, monosodium citrate and trisodium citrate in a method for producing a reconstituted rice kernel, wherein the molar ratio of ferric pyrophosphate to citrate salt is between 0.01 and 20.

13. Iron enriched rice comprising white natural rice kernels and reconstituted rice kernels according to claim 1, wherein the rice contains 0.1 to 10 wt.-% of reconstituted rice.

14. Process to prepare reconstituted rice kernels according to claim 1 comprising the following steps:
(a) dry heat treatment of the rice matrix (pre-treatment step);
(b) comminuting of the rice matrix;
(c) adding water and/or steam to the comminuted rice matrix material to obtain a paste containing about 15 to 40 wt.-% of water (hydration step);
(d) adding 0.015 to 10 wt.-% ferric pyrophosphate, 0.01 to 40 wt.-% citric acid and/or citrate salt, selected from potassium citrate, monosodium citrate and trisodium citrate, and optionally at least one micronutrient to the paste;
(e) exposing the paste obtained in the preceding steps to shear force while heating it to about 70 to 110° C. for no more than about 10 minutes until the rice starch is semigelatinized; (preconditioning step);
(f) forming the semigelatinized mass to strands and cutting them to obtain grains similar or equal to the size of rice grains; and (forming step);
(g) drying the grains to a moisture content of no more than 15 wt.-% (drying step).

15. Process according to claim 14, wherein step d) is performed after step e).
